(19) United States
(12) Patent Application Publication
(10) Pub. No.: US 2023/0280786 A1
(43) Pub. Date: Sep. 7, 2023

(54) Display Panel Mounting Frame Enclosure for Desktop Computer Cases

(71) Applicant: Matthew J. Harvey, El Monte, CA (US)

(72) Inventor: Matthew J. Harvey, El Monte, CA (US)

(73) Assignee: DISPLAYMOD, EI Monte, CA (US)

(21) Appl. No.: 18/163,850

(22) Filed: Feb. 2, 2023

Related U.S. Application Data
(60) Provisional application No. 63/306,063, filed on Feb. 2, 2022.

(51) Int. Cl. G06F 1/16; G06F 1/18; B29C 64/118

(52) U.S. Cl. CPC G06F 1/1601; G06F 1/183; G06F 1/181; B29C 64/118; B33Y 10/00

(57) ABSTRACT

A display panel mounting frame enclosure for desktop computer cases is disclosed. The assembly may include two parts, conjoined together: a top case frame and a backplate mounting module, each formed from a single part and configured to contain a computer display panel. When combined together, the top case frame, backplate mounting module, and computer display panel form a mountable computer case display monitor. The top case frame and backplate mounting module form a frame, cosmetic exterior, and primary housing of the computer display panel, as well as provide desktop computer case mounting. The assembly may include a plurality of subassemblies such as fastener nuts, screws, and magnets that are carried by the backplate mounting module and work in conjunction with hardware mounting fixtures inside desktop computer cases.

### BACKGROUND

### Technical Field of Invention

The present invention relates to electronic visual display mounting frame enclosure systems. Particularly, embodiments of the present disclosure relate to computer display panel mounting frame enclosure systems for desktop computer cases.

### BACKGROUND TECHNOLOGY

Vision is the most compelling of human abilities; after all, the adage that a picture is worth a thousand words is still very much in use. So, in this increasingly visual, digital world it should be no surprise that technology surrounding interfacing with visual, digital information has come a long way. Particularly, computer display panels have been created such that their size and power consumption allow them to be powered over Universal Serial Bus (USB), thus making the computer display panel especially useful for video interface with personal computers. It is natural then that computer enthusiasts would want to add these display panels to their desktop computer cases for the purpose of hardware monitoring, supplemental video interfacing, or creating additional visual appeal. A display panel mounting frame enclosure system for desktop computer cases is a particularly effective and compelling way for people to experience interfacing with visual information inside their personal computer case and such systems are the focus of the present disclosure.

### SUMMARY OF THE INVENTION

The present disclosure is directed to computer display panel mounting frame enclosures for computer cases, mounting systems, and methods for making, using, and connecting the modules and systems described herein. The assembly may include two integral parts, conjoined together: a top case frame and backplate mounting module, each formed from a single part. The top case frame and backplate mounting module may be sized and configured to contain a computer display panel between them. When combined together, the top case frame, backplate mounting module, and computer display panel form a mountable computer case display monitor. The top case frame provides an enclosure, frame and cosmetic exterior of the computer display panel. The top case frame also serves as the primary housing of the computer display panel. The backplate mounting module provides desktop computer case mounting, support to the computer display panel, and connection to the top case frame. The assembly may include a plurality of subassemblies such as fastener nuts, screws, and magnets that are carried by the backplate mounting module. The backplate mounting module may be configured to contain a plurality of mounting mechanisms that work in conjunction with commonly found hardware mounting fixtures inside desktop computer cases. The top case frame and backplate mounting module may be formed via additive manufacture from molten thermoplastic material that has been extruded layer by layer or injection molded to form walls, openings, attachment areas, and cosmetics areas of both parts. Openings in the integral top case frame and backplate mounting module may be configured to correspond with cable ports and visual displays of the computer display panel.

### BRIEF DESCRIPTION OF THE DRAWINGS

FIGS. 1A and 1B are perspective views of an illustrative mountable computer case display monitor that may have a top case frame and a backplate mounting module in accordance with an embodiment in the current invention.

FIG. 2 is an exploded perspective view of an illustrative mountable computer case display monitor that may have a top case frame and a backplate mounting module in accordance with an embodiment in the current invention.

FIG. 3A is a top perspective view of an illustrative top case frame in accordance with an embodiment in the current invention.

FIG. 3B is a bottom perspective view of an illustrative top case frame in accordance with an embodiment in the current invention.

FIG. 4A is a top perspective view of an illustrative backplate mounting module in accordance with an embodiment in the current invention.

FIG. 4B is a bottom perspective view of an illustrative backplate mounting module in accordance with an embodiment in the current invention.

FIG. 5 is an exploded perspective view of an illustrative mountable computer case display monitor installation using mounting screws in accordance with an embodiment in the current invention.

FIG. 6 is an exploded perspective view of an illustrative mountable computer case display monitor installation using mounting magnets in accordance with an embodiment in the current invention.

FIG. 7 is a flow chart of illustrative steps involved in forming a top case frame and backplate mounting module, as well as assembling a mountable computer case display monitor with the top case frame and backplate mounting module.

### DETAILED DESCRIPTION

The present invention relates to computer display mounting structures. Computer display mounting structures may be provided that enhance the functionality of a computer display while retaining or even improving desired levels of durability and aesthetics. The present invention describes a mountable computer case display enclosure comprising of a top case frame, wherein an electronic display panel is mounted and framed, and to which a backplate mounting module is connected; and a backplate mounting module, wherein a top case frame is connected, in which a plurality of mounting subassemblies is contained, and to which the device is mounted to a desktop computer case. All together, the top case frame, the backplate mounting module, and the electronic display panel form a mountable computer case display monitor, which increases the functionality and aesthetic of the electronic display panel by adding the ability to affix the device to a desktop computer case oriented to be viewed more easily by the user.

One aspect of the invention may relate to a portion of a mountable computer case display device that includes an enclosure formed by two parts (e.g., top case frame and backplate mounting module). In one embodiment, a majority if not all of the internal components such as electrical components of the portion of the display device are assembled within the top case frame, while the backplate mounting modules serves as a cover that cooperates with the top case frame to fully enclose the internal components (e.g., they cooperate to form the housing of the portion of the display device) as well as mount the resulting device to a computer case. The top case frame may carry the electrical components and frame the visual display, while the backplate mounting module contains the mounting equipment. The backplate mounting module may include attachment features on its topside for securing components of the display.

Another aspect of the invention relates to a housing portion (e.g., top case frame and backplate mounting module) that unifies several structural/ornamental features into a single integral part. For example, the housing portion may serve as a protective shell with an integral frame while providing the cosmetic exterior and visual display framing. The housing portion may also provide integral mounting features for helping secure the housing portion to various subassemblies. With this type of arrangement, the housing portion (e.g. display panel mounting frame enclosure) may serve as an exoskeleton and visual display frame for computer display panels such as those powered over Universal Serial Bus (USB), while also serving to mount the display panel to a desktop computer case. These three features may work together in one single part. The housing portion may also serve as a heat sink to the computer display device.

In one embodiment, the integral housing portion may be formed from an extrudable or injection moldable material, and more particularly a thermoplastic material. This may, for example, be accomplished with an additive manufacturing process. A majority if not all of the surfaces of the integral housing portion may be additively manufactured or otherwise formed.

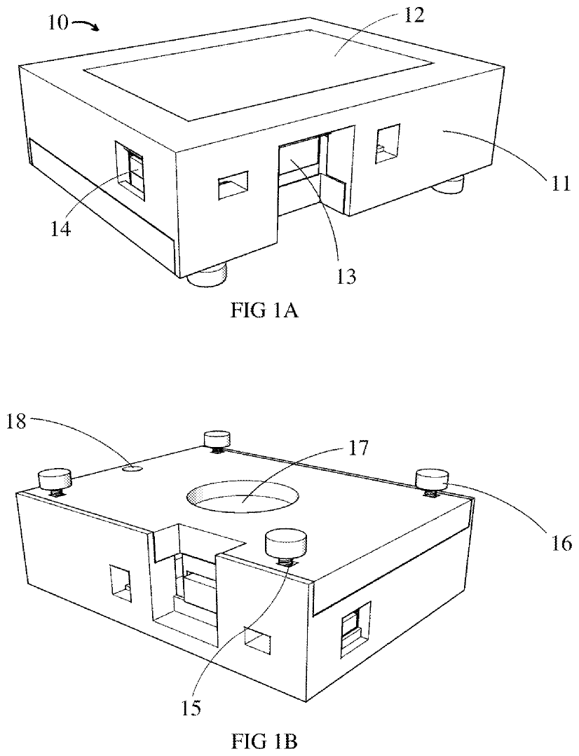

Embodiments of the invention are discussed below with reference to FIGS. 1-7. The detailed description given herein with respect to these figures is for explanatory purposes as the invention extends beyond these limited embodiments.

FIG. 1 is a diagram of a mountable computer case display monitor 10, in accordance with one embodiment of the invention. Mountable computer case display monitor 10 may, for example, attach to a personal computer case using the mounting frame enclosure 11. As shown, mountable computer case display monitor 10 may include an electronic visual display 12 which may feature a video cable input socket 13 and powered by the Universal Serial Bus input socket 14. The mounting system 15 may allow for multiple mounting scenarios for the device such as with screw mounting 16 and magnet mounting 17 systems which may work independently to connect the device to a corresponding environment such as screw-mounted hardware fixtures and magnetic surfaces which are commonly found inside desktop computer cases. The mounting frame enclosure 11 may be made from two parts which may securely fasten to each other using an enclosure connector screw system 18. As such, the mounting frame enclosure 11 may include various features that improve the function and aesthetic appearance of electronic visual display panels by allowing the device to be mounted securely to a desktop computer case and oriented in order to be viewed by the user.

The top case frame 18 may, for example, be used as an electronics housing, visual display frame, and cosmetic exterior and may also couple to the backplate mounting module 20. The backplate mounting module 20 may be used as a bottom cover for the device, support an electronic display, and may contain mounting system 15 and magnet mounting 17. As such, they may include various features that improve the function and aesthetic appearance of electronic computer display panels such that they may be mounted and framed more easily inside a desktop computer case.

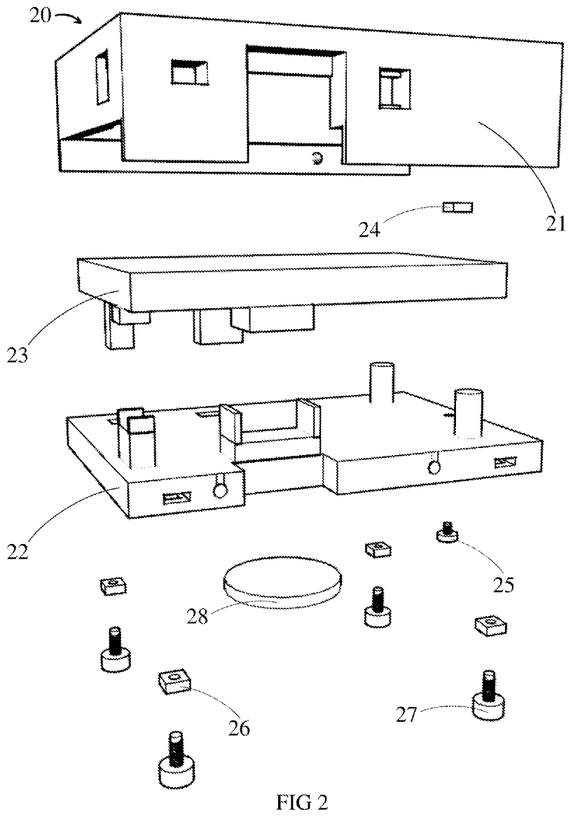

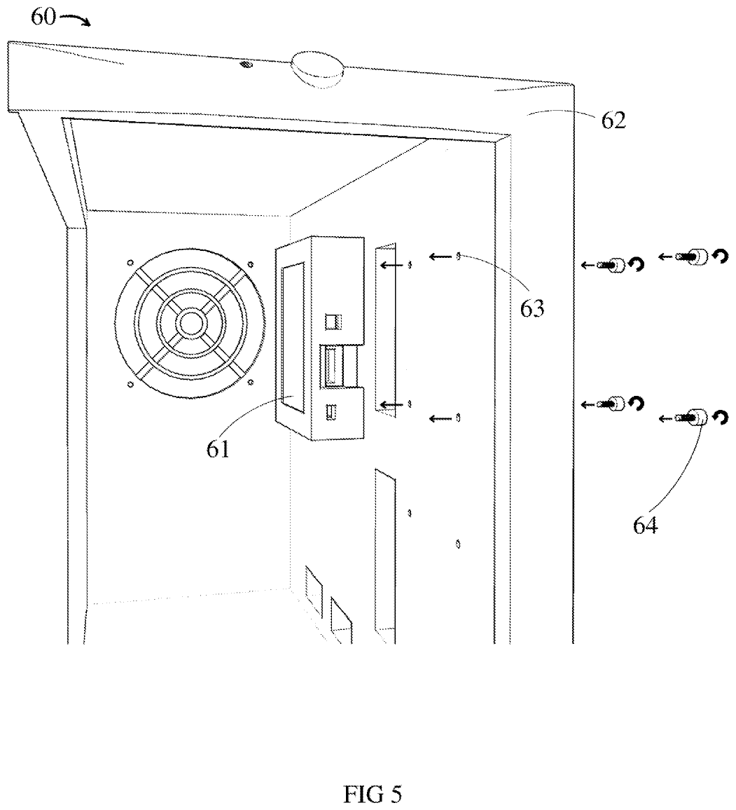

FIG. 2 is an exploded view of a mountable computer case display 20, in accordance with one embodiment of the present invention. The mountable computer case display 20 may, for example, correspond to the mountable computer case display shown in FIG. 1. As shown, the mountable computer case display 20 includes a top case frame 21, backplate mounting module 22 and electronic visual display panel 23 which cooperate with the enclosure fastener nut 24 and the enclosure connector screw 25 to form a mountable computer case display. The mountable computer case display then uses a plurality of mounting mechanisms to ensure connection with an appropriate mounting environment inside a computer case such as a screw nut mount which uses a mounting system fastener nut 26 and a mounting system screw 27 or, alternatively a magnet mounting system which uses a magnet mounting system magnet 28. The plurality of mounting mechanisms contained in the backplate mounting module 22 serve to attach the mountable computer case display 20 to a desktop computer case shown in FIG. 5. and may consist of mounting system fastener nuts 26 and mounting system screws 27, which serve to mount the display to hardware mounting fixtures inside desktop computer cases; and magnet mounting system magnet 28 which serves to mount the device to magnetic surfaces.

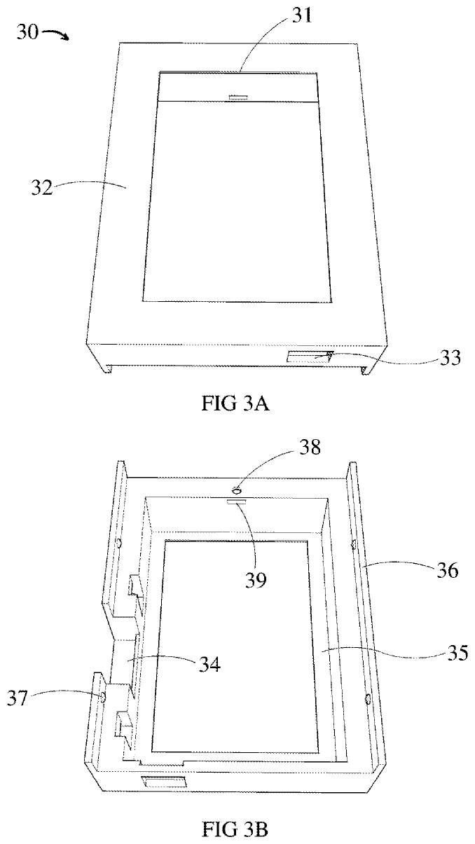

FIGS. 3A and 3B are top and bottom views, respectively, of a top case frame 30 of a mountable computer case display, in accordance with one embodiment of the present invention. The top case 30 may, for example, correspond to the top case frame shown in FIG. 2. The top case frame 30 is configured to serve as an outer enclosure, visual display frame and cosmetic exterior of the mountable computer case display monitor. The top case frame 30 may also be configured to serve as the main housing for the electrical components such as the electronic visual display panel shown in FIG. 2. In one embodiment, the top case frame 30 may be formed entirely from a single piece of material. More particularly, it may be formed from extruded plastics such as thermoplastics or similar material. In one embodiment, the top case frame 30 is formed by extrusion of a single material via additive manufacture. The top case frame 30 enclosure comprises a framed computer display panel and subassemblies to connect to the backplate mounting module shown in FIG. 2.

As shown in FIGS. 3A, the top case frame 30 includes a visual display cut-out or void 31 which allows viewing of the electronic visual display panel's video output and visual display frame bezel 32 which contains the electrical components behind it and frames the video output of the display panel such as shown in the electronic visual display shown in FIG. 1A. The top case frame 30 also contains the power supply cable cavity or void 33 to facilitate access to power input as well as the video cable cavity 34 to facilitate access to audio or video inputs. Another component of top case frame 30 is the visual display panel cavity 35 which both contains the device and provides a frame bezel for the visual display. Referring to FIGS. 3B, the backplate container walls 36 may define a cavity or void for placement of a cover featuring mounting hardware, which also supports the internal components inside in their desired position such that the visual display or video output of the electronic display panel is centered and so the panel's available cable input/output sockets are accessible. The conjunctive protrusions 37 may serve to secure the two parts by conjoining with conjunctive depressions on the backplate, shown in a later embodiment. The top case frame 30 also features a connector screw hole 38 and connector nut cavity 39 which cooperate with fastening hardware in order to fasten the top case frame 30 to the backplate mounting module as featured in FIG. 2. The top case frame 30 serves as the exoskeleton for the device, provides an enclosure for the electronic computer display panel, and serves as an exterior visual display frame.

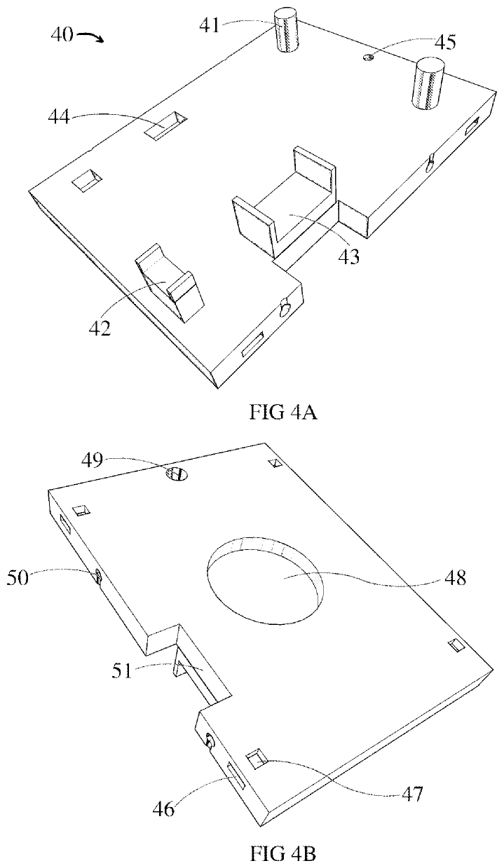

FIGS. 4A and 4B are top and bottom views, respectively, of a backplate mounting module 40 of a mountable computer case display, in accordance with one embodiment of the present invention. The backplate module 40 may, for example, correspond to the backplate mounting module shown in FIG. 2. The backplate module 40 is configured to serve as the device's back cover, electronic device support and as the mounting hardware to the mountable computer case display. In one embodiment, the backplate mounting module 40 may be formed entirely from a single piece of material. More particularly, it may be formed from extruded plastics such as thermoplastics or similar material. In one embodiment, the backplate module 40 is formed by extrusion of a single material via additive manufacture. The backplate mounting module 40 comprises a plurality of mounting assemblies attached to inner surfaces and subassemblies to connect to a top case frame shown in FIG. 2.

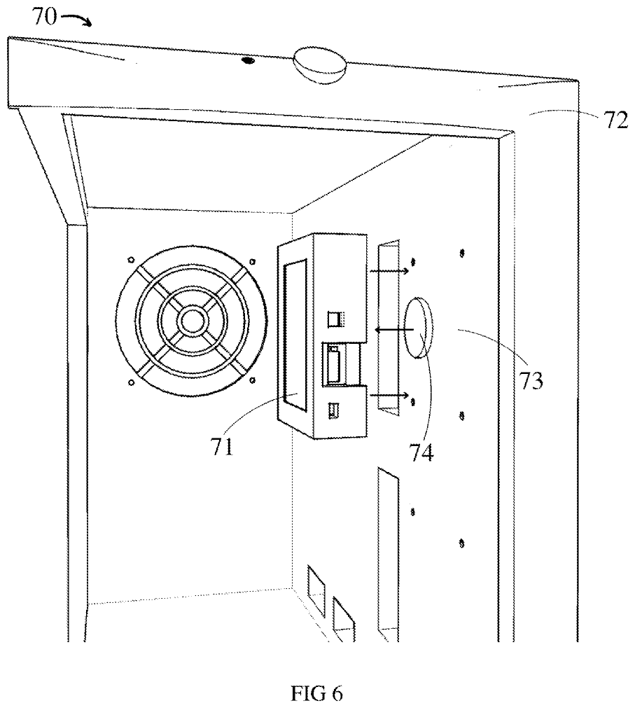

As shown, the backplate mounting module 40 may include an electronic device support structure 41 which supports the back of the computer display, holding it in place alongside other structures such as the power supply socket support structure 42 and video cable socket support structure 43 which may serve to cover and hold their respective cable sockets in place. Further, the backplate mounting module 40 may contain electronic device feature cavity 44 which may serve to support a respective feature on the computer display being placed inside. The backplate mounting module 40 may also be connected to the top case frame from FIG. 3, and this may be facilitated through the connector screw hole 45 which may allow the threads of the connector screw seen in FIG. 2 to pass through, ensuring the fastening together of the backplate mounting module with the top case frame shown in FIG. 2. The backplate mounting module 40 serves as the base for the mountable computer case display, provides a plurality of mounting subassemblies for attachment of the mountable computer case display, and serves to mount the electronic computer display panel to the desktop computer case shown in FIG. 5 and FIG. 6.

The backside of backplate mounting module 40 may contain the mounting features of the device such as the mounting fastener nut cavity 46 which may contain a receiving fixture to receive the captive faster nuts from FIG. 2 and for access to the fastener nut to connect to their respective fastener screws while remaining in place through the mounting fastener hole 47. The backside of backplate mounting module 40 may also contain a magnet mounting function such as mounting magnet cavity 48 which may facilitate the installation of the mounting magnet from FIG. 2, holding the magnets in place and allowing for mounting of the device on magnetic surfaces. The backplate mounting module 40 may contain inner surfaces providing attachment of a plurality of mounting subassemblies for attachment to desktop computer cases consisting of fastener nuts, corresponding fastener screws, and mounting magnets as shown in FIG. 2. Another feature of the backside of backplate mounting module 40 may be a countersunk connector screw cavity 49 which may facilitate the insertion of the connector screw from FIG. 2 and allow for fastening of the two parts. The sides of backplate mounting module 40 may also feature conjunctive depressions 50 which align with the conjunctive protrusions from FIG. 3 and allow a secure, toolless connection of the two parts. Another component of the backplate mounting module 40 may be the cable input cavity or void 51 which may facilitate the insertion of cables of a variety of sizes, shapes, and angles.

FIG. 5 is an exploded view of the fastener installation of a mountable computer case display monitor 60, in accordance with one embodiment of this invention. The fastener installation of a mountable computer case display monitor 60 may be accomplished through attaching computer case display 61 to a desktop computer case 62 through each device's requisite mounting hardware. Desktop computer case 62 may represent an assembly comprising of an operable desktop personal computer comprised of a desktop computer case 62 having a transparent portion, a power supply unit, a memory storage device, an integrated processor, and a mountable computer case display monitor 61 oriented to be viewed by the user, wherein the mountable computer case display monitor 61 comprises the top case frame and the backplate mounting module shown in FIG. 2. The mountable computer case display monitor 61 may comprise of a display panel mounted installed in the top case frame, circuitry and mounting equipment connected to the backplate mounting module, a connection method to attach the integral top case frame and the backplate mounting module to be formed as a single part that serves as an exoskeleton for the device; and a plurality of mounting mechanisms contained in the device that allow for attachment to the desktop computer case 62. The mountable computer case display monitor 61 may, for example, correspond to the computer case display shown in FIG. 1. The computer case display 61 may feature mounting hardware in sizes, location, and features such that they correspond with desktop computer case hardware mounting fixture 63. Desktop computer case hardware mounting fixture 63 may refer to commonly found fixtures for mounting of computer hardware on desktop computer case 62 which allow for the mounting of hardware (e.g. computer case fans, storage drives). Desktop computer case hardware mounting fixture 63 may constitute small openings that allow the passage of computer case display screws 64 in order to fasten to computer case display 61. Computer case display screws 64 may, for example, correspond to the mounting system screws shown in FIG. 2. The fastener mountable computer case display monitor 60 and the desktop computer case 62 are both oriented to be viewed by the user.

FIG. 6 is an exploded view of the magnet installation of a mountable computer case display monitor 70, in accordance with one embodiment of this invention. The magnet installation of a mountable computer case display monitor 70 may be accomplished through attaching computer case display 71 to a desktop computer case 72 through each device's requisite mounting hardware. The computer case display 71 may, for example, correspond to the computer case display shown in FIG. 1. The computer case display 71 may feature mounting hardware in sizes, location, and features such that they correspond with desktop computer case magnetic surface 73. Desktop computer case magnetic surface 73 may refer to a flat surface or wall found in a desktop computer case 72 which is magnetic due to its material composition. Desktop computer case magnetic surface 73 may constitute a magnetic surface which allows for the placement of a computer case display magnet 74 in order to attach computer case display 71. Computer case display magnet 74 may, for example, correspond to the magnet mounting system magnet shown in FIG. 2. The magnet mountable computer case display monitor 70 and the desktop computer case 72 are both oriented to be viewed by the user.

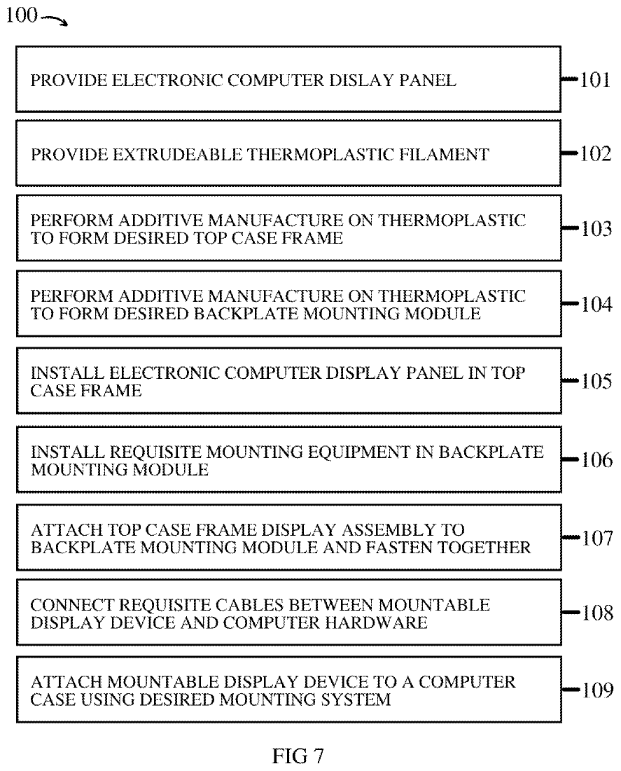

FIG. 7 is a method 100 of assembling a mountable computer case display monitor 10, in accordance with one embodiment of the present invention. The mountable computer case display monitor 10 may generally correspond to the mountable computer case display monitor and components shown in the previous figures.

The method 100 may include block 101 where an electronic visual display panel 23 (e.g. a display panel powered over Universal Serial Bus) is provided. The electronic visual display panel 23 may have outside dimensions that are near the desired dimensions of the top case frame 21 and the backplate mounting module 22. It may be slightly smaller in X, Y and Z dimensions, in order to fit inside. The dimensions of the top case frame 21 and the backplate mounting module 22 can range in value between 0% and 5% larger, 5% and 10% larger, 10% and 15% larger, 15% and 20% larger, and also preferably no more than 25% larger in each X, Y, and Z dimensions compared to the dimensions of the electronic visual display panel 23 contained between them. In order to keep the resulting mountable computer case display monitor 10 as small as possible, the top case frame 21 and the backplate mounting module 22 should preferably range in value between 0% and 5% larger than each of the X, Y, and Z dimensions of the electronic visual display panel 23.

The method 100 may also include block 102 where a thermoplastic material is provided. In one embodiment, the thermoplastic material is heated, melted, and extruded via additive manufacture to form the top case frame 21 and backplate mounting module 22. The method 100 may refer to manufacturing of plastic parts by an additive manufacturing operation to produce two finished parts that serve as the top case frame 21 and the backplate mounting module 22, enclosing the electronic computer display panel 23 in a mounting frame enclosure 11, that provides mounting capabilities for the mountable computer case display monitor 10, and that provides a cosmetic exterior for the device. The top case frame 21 and the backplate mounting module 22 each comprise a single piece of plastic wherein the top case frame 21 and the backplate mounting module 22 are formed exclusively from that plastic. The method 100 additive manufacturing step may be performed by layer-by-layer extrusion or injection molding of a molten thermoplastic material using an additive manufacturing operation. The additive manufacturer operation creates a plastic part comprising a thermoplastic material, wherein the additive manufacture operation of that plastic part comprises producing surfaces, walls, openings, structures, and attachment areas of the single plastic part.

The method 100 may also include block 103 where an additive manufacturing process may be performed on thermoplastic material to form a top case frame 21. The additive manufacturing process may be configured to melt and extrude thermoplastic filament in layers until the desired top case frame 21 is rendered. For example, the additive manufacturing may include forming the structure of the top case frame 21 such as the visual display cut-out or void 31, display frame bezels 32, electronic display panel cavity 35, port openings such as video cable cavity 34 and power supply cable cavity 33, and device structures such as walls and conjunctive protrusions 37. The additive manufacturing process may also include forming attachment areas for various components of the device. The attachment areas may include cavities, recesses, slots, bosses, frame members, and the like. The top case frame 21 may be manufactured to have outside dimensions that are near the dimensions of the related electronic visual display panel 23. It may be slightly larger in X, Y, and Z dimensions in order to fit the electronic visual display panel 23 inside. The dimensions of the top case frame 21 can range in value between 0% and 5% larger, 5% and 10% larger, 10% and 15% larger, 15% and 20% larger, and also preferably no more than 25% larger in each X, Y, and Z dimensions compared to the dimensions of the electronic visual display panel 23 contained inside. In order to keep the resulting mountable computer case display monitor 10 as small as possible, the top case frame 21 should preferably range in value between 0% and 5% larger than each of the X, Y, and Z dimensions of the electronic visual display panel 23.

The method 100 may also include block 104 where an additive manufacturing process may be performed on thermoplastic material to form a backplate mounting module 22. The additive manufacturing process may be configured to melt and extrude thermoplastic filament in layers until the desired backplate mounting module is rendered. For example, the additive manufacturing may include forming the structure of the backplate mounting module 22 such as electronic device support structures 41, electronic device feature cavities 44, mounting fastener nut cavities 46, video cable socket support structure 43, and power supply socket support structures 42. The additive manufacturing process may also include forming attachment areas for various components of the device. The attachment areas may include cavities, recesses, slots, bosses, frame members, and the like. The backplate mounting module 22 may be manufactured to have outside dimensions that are near the dimensions of the electronic visual display panel 23 and the top case frame 21. The backplate mounting 22 module may be no more than 25% smaller in X, Y, and Z dimensions than the dimensions of the top case frame 21. The dimensions of the backplate mounting module 22 can range in value between 0% and 5% larger, 5% and 10% larger, 10% and 15% larger, 15% and 20% larger, and also preferably no more than 25% larger than the electronic visual display panel 23. In order to keep the resulting mountable computer case display monitor 10 as small as possible, the backplate mounting module 22 should preferably range in value between 0% and 5% larger than each of the X, Y, and Z dimensions of the electronic visual display panel 23.

The method 100 may also include block 105 where the provided electronic visual display panel 23 is installed in the top case frame 21. This process can be done manually where an electronic visual display panel 23 is placed by hand in an appropriately sized top case frame's computer display cavity 35. The electronic visual display panel 23 may fit firmly inside the top case frame 21 with visual display frame bezels 32 on the outside framing and centering the electronic visual display panel's view port. The integral top case frame 21 that serves as the exoskeleton for the device is formed exclusively from plastic and provides an enclosure and visual frame for the electronic computer display panel 23 shown in FIG. 2, and serves as a primary structure for the mounting frame enclosure 11 shown in FIG. 1.

The method 100 may also include block 106 where mounting equipment may be installed in the backplate mounting module 22. This process can be done manually where mounting system fastener nuts 26 and magnet mounting system magnets 28 may be placed by hand in a backplate mounting module's mounting system cavities such as mounting fastener nut cavity 46 and mounting magnet cavity 48. The mounting equipment may fit firmly inside their cavities with access to their respective mounting mechanism. For example, mounting system fastener nuts 26 may be placed inside the backplate mounting module's mounting fastener nut cavities 46, allowing them to remain captive with their threads accessible via the respective mounting fastener holes 47. A magnet mounting system magnet 28 may also be placed inside the backplate mounting module's mounting magnet cavity 48, which may allow the backplate mounting module to attach to magnetic surfaces such as desktop computer case magnetic surface 73 as shown in FIG. 6. The integral backplate mounting module 22 that serves as the base for the device is formed exclusively from plastic and provides an enclosure to the electronic computer display panel 23 shown in FIG. 2 and serves to contain the mounting equipment for attachment to a desktop computer case shown in FIGS. 5 and 6.

The method 100 may also include block 107 where the top case frame 21 assembly may be attached and fastened to the corresponding backplate mounting module 22. This process may be done manually where the backplate mounting module 22 may be placed inside the back of the top case frame 21, closing the electronic components inside and creating a mounting frame enclosure 11. The parts of the display enclosure may be secured together using the enclosure connector screw 25 which may be inserted in the countersunk connector screw cavity 49 on the backplate mounting module 22 and fastened to the enclosure fastener nut 24 inside the top case frame 21.

The method 100 may also include block 108 where the requisite cables to power the device may be connected between the mountable computer case display monitor 10 and the computer hardware inside the respective desktop computer case as shown in FIG. 5 and FIG. 6. This process may be done manually where the cables to power the device and deliver audio/video signal may be connected on one end to ports on the mountable computer case display monitor 10 and on the other end to ports on the computer hardware. Features on the top case frame 21 and backplate mounting module 22 facilitate access to cable sockets on the mountable computer case display monitor 10 such as power supply cable cavity or void 33, video cable cavity 34, video cable socket support structure 43, and power supply socket support structures 42.

The method 100 may also include block 109 where the mountable computer case display monitor 10 may be attached to a hardware mounting fixture on or inside a respective computer case using the requisite mounting system such as shown in FIG. 5 and FIG. 6. This process may be done manually where the mountable computer case display monitor may be fastened to the computer case using the computer case display screws 64 such as shown in FIG. 5 or by placing the mountable computer case display monitor on a desktop computer case magnetic surface 73 using the magnet mounting system magnet 28. For example, the mountable computer case display monitor may feature a fastener-mounting system which allows for mounting screws to pass through a hole in a desktop computer case's hardware mounting fixture 63 and into the mounting fastener holes 47 on the backplate mounting module 22, securing the mountable computer case display monitor to the desktop computer case. Additionally, the mountable computer case display monitor may feature a magnet mounting system where a magnet mounting system magnet 28 may be placed inside the mounting magnet cavity 48 on the backplate mounting module 22, attaching the mountable computer display monitor magnetically to ferrous or magnetic surfaces such as the desktop computer case magnetic surface 73 commonly found on the interior or exterior of a desktop computer case. The ability to connect the mountable computer display monitor through the use of a plurality of mounting systems featured in the backplate mounting module 22 may give electronic visual display panels 23 additional features, connectivity, durability, and desirability.

The foregoing is merely illustrative of the principles of this invention and various modifications can be made without departing from the scope and spirit of the invention.

What is claimed is:

1. A mountable computer case display enclosure, comprising:
a top case frame, wherein an electronic visual display panel is mounted and framed, and to which a backplate mounting module is connected; and
a backplate mounting module, wherein a top case frame is connected, in which a plurality of mounting subassemblies is contained, and to which the electronic visual display panel is mounted to a desktop computer case.

2. The mountable computer case display enclosure defined in claim 1 wherein the top case frame comprises a framed electronic visual display panel and subassemblies to connect to the backplate mounting module in order to form a mountable computer case display monitor.

3. The mountable computer case display enclosure defined in claim 1, wherein the backplate mounting module comprises a plurality of mounting assemblies attached to inner surfaces and subassemblies to connect to the top case frame in order to form a mountable computer case display monitor.

4. The mountable computer case display enclosure defined in claim 2, wherein the top case frame serves as the exoskeleton for the device, provides an enclosure for the electronic visual display panel, and serves as an exterior visual display frame.

5. The mountable computer case display enclosure defined in claim 3, wherein the backplate mounting module serves as the base for the mountable computer case display monitor, provides a plurality of mounting subassemblies for attachment of the mountable computer case display monitor, and serves to mount the electronic computer display panel to the desktop computer case.

6. The mountable computer case display enclosure defined in claim 5, wherein the backplate mounting module contains inner surfaces providing attachment of a plurality of mounting subassemblies for mountable computer case display monitor attachment to desktop computer cases, comprising:
fastener nuts contained in inner surfaces, corresponding with screws for attachment; and
mounting magnets placed in inner cavities, working in conjunction with magnetic surfaces.

7. The mountable computer case display enclosure defined in claim 6, wherein the backplate mounting module contains inner surfaces comprising a cavity having a receiving fixture to receive fastener nuts and for access to the fastener nut to connect to their respective fastener screws while remaining in place.

8. The mountable computer case display enclosure defined in claim 6, wherein the backplate mounting module contains inner surfaces comprising a cavity which allows the installation of mounting magnets and which hold the magnets in place.

9. The mountable computer case display enclosure defined in claim 1, wherein the top case frame and the backplate mounting module each comprise a single piece of plastic and wherein the top case frame and the backplate mounting module are formed exclusively from that plastic.

10. A method of forming the integral top case frame and backplate mounting module for a mountable computer case display enclosure, comprising:
manufacturing plastic parts by an additive manufacturing operation to produce two finished parts that serve as the top case frame and the backplate mounting module, enclosing the electronic visual display panel in a mountable computer case display enclosure, that provides mounting capabilities for the mountable computer case display enclosure, and that provides a cosmetic exterior for the mountable computer case display monitor.

11. The method defined in claim 10 wherein the additive manufacture step comprises layer-by-layer extrusion or injection molding of a molten thermoplastic material using an additive manufacture operation.

12. The method defined in claim 11, wherein the additive manufacturer operation creates a plastic part comprising a thermoplastic material, wherein the additive manufacture operation of that plastic part comprises producing surfaces, walls, openings, structures, and attachment areas of the single plastic part.

13. An assembly comprising:
an operable desktop personal computer comprised of a desktop computer case having a transparent portion, a power supply unit, a memory storage device, an integrated processor, and a mountable computer case display monitor oriented to be viewed by the user, wherein the mountable computer case display monitor comprises a top case frame and a backplate mounting module, the mountable computer case display monitor comprising:
a display panel mounted installed in the top case frame;
circuitry and mounting equipment connected to the backplate mounting module;
a connection method to attach the integral top case frame and the backplate mounting module to be formed as a single part that serves as an exoskeleton for the device; and
a plurality of mounting mechanisms contained in the device that allow for attachment to the desktop computer case.

14. The mountable computer case display enclosure defined in claim 13, wherein the integral top case frame and backplate mounting module that serves as the exoskeleton for the device are formed exclusively from plastic and provide an enclosure and visual frame for the electronic visual display panel, serve as a primary structure for the mountable computer case display monitor, and serve to contain the mounting equipment for attachment to a desktop computer case.

15. The mountable computer case display enclosure defined in claim 13, wherein the plurality of mounting mechanisms contained in the device that allow for attachment to a desktop computer comprise: fastener nuts and screws, which serve to mount the electronic visual display panel to hardware mounting fixtures inside desktop computer cases; and magnets, which serve to mount the device to magnetic surfaces.

16. The desktop personal computer defined in claim 13, wherein the mountable computer case display monitor and the desktop computer case are both oriented to be viewed by the user.
